(19) United States
(12) Patent Application Publication
(10) Pub. No.: US 2025/0122886 A1
(43) Pub. Date: Apr. 17, 2025

(54) VARIABLE SPEED PUMP OF AN ELECTRIC MACHINE

(71) Applicant: EPROPELLED INC., Gilford, NH (US)

(72) Inventor: Nabeel SHIRAZEE, Cardiff (GB)

(73) Assignee: EPROPELLED INC., Gilford, NH (US)

(21) Appl. No.: 18/693,263

(22) PCT Filed: Sep. 29, 2022
(86) PCT No.: PCT/US2022/077284

§ 371 Date: Mar. 19, 2024

(30) Foreign Application Priority Data
Sep. 29, 2021 (IN) 202141011283

(51) Int. Cl. F04D 29/58; F04D 1/00; F04D 13/06; F04D 15/00

(52) U.S. Cl. CPC F04D 29/5806; F04D 13/0686; F04D 15/0066; F04D 29/5813; F04D 1/00

(57) ABSTRACT

Disclosed herein are embodiments a compact, cost-effective variable speed pump (100) for improving the cooling of an outer rotor electric machine including: a wet/fluid compartment (101), a variable speed drive (102) with power electronics, a liquid cooling plate (103) and an outer rotor permanent magnet (104) as shown in FIG. 1. The drive (102) is strategically positioned adjoining the wet/fluid compartment (101) as the heat generated by the electronics is transmitted to the flowing liquid. The liquid cooling plate (103) having cooling pipes (5a, 5b) is interposed between the power electronics and the outer rotor motor (104) comprising a rotor (9) arranged on the outside of a stator (6), wherein the stator (6) included concentrated windings (7). The cooling pipes (5a, 5b) carry liquid through the inlet pipe (5a) and discharge through the outlet pipe (5b) to effectively cool both the power electronics on one side and the motor windings (7) on the other side.

### FIELD OF THE INVENTION

The present invention generally relates to electric machines. Embodiments relate to the cooling of electronics and an outer rotor permanent magnet electric machine for pump applications.

### BACKGROUND

Traditionally, most pumps are driven by induction motors due to their high reliability, low cost, low maintenance and fair efficiency. The efficiency of these motors' typically ranges from 70%-85%.

In an induction motor, electrical voltage and current are passed into the stator. This creates a rotating magnetic field in the stator. An offset winding induces a current in the squirrel cage bars of the rotor and creates a magnetic field in the rotor. The rotor rotates at a slower speed than the rotating magnetic field of the stator thus creating a slip. This slip increases with the increased torque requirement of the motor. This type of motor is called an asynchronous machine, which is simpler in construction but is not as efficient as a permanent magnet motor. Furthermore, it is more complex to control an induction motor with a variable speed drive than a permanent magnet motor.

On the other hand, in a permanent magnet motor, the rotor rotates with the rotating magnetic field of the stator. This type of motor is called a synchronous machine. Since the magnets create the magnetic field in the rotor, the permanent magnet synchronous machine is more efficient compared to an induction motor of the same size where the magnetic field in the rotor is created by the induced current flowing in the squirrel cage bars. The variable speed drive for a permanent magnet motor is much simpler than for an induction machine.

In recent times, industries such as automotive, aerospace, marine, railways etc are undergoing a rapid transformation that aims primarily to reduce carbon emissions. This global drive towards electric propulsion systems has also led the pump industry to develop new business strategies to attain greener, more energy-efficient pumps.

Apart from the efficiency, cooling is the most important aspect when designing a compact, energy-efficient pump. Previously, the pumps were cooled by air cooling methods which are inefficient when compared to liquid cooling as the liquid absorbs heat at approximately 24 times faster than air. The large specific heat capacity of liquid is over 4 times that of air, making it an ideal coolant for pump applications, where the cooling liquid is already present in the system.

CN113482939A, a published application titled “High-efficiency water-cooling outer rotor type permanent magnet intelligent water pump with integrated controller” discloses an integrated controller high-efficiency water-cooling outer rotor type permanent magnet intelligent water pump, where the pump body is arranged in the shell; the impeller is arranged in the pump body at the water inlet and fixedly connected with the pump body through an impeller locking nut; the front end cover is fixedly connected with the shell and fixedly connected with the pump body through a front bearing; the rear end cover is fixedly connected with the shell and fixedly connected with the pump body through a rear bearing; the stator core is fixed with the front end cover through a stator core fixing pressing plate, a stator coil is arranged on the stator core, the end part of the stator coil close to the front end cover is provided with a heat conducting glue, and the heat conducting glue is arranged between the stator core and the front end cover; rotor yoke, pressure sensor and controlling means. The invention detects the water pressure of the water outlet through the pressure sensor, realizes energy saving and intelligent control, and utilizes the working medium water to directly cool the front-end cover connected with the stator core to increase the heat dissipation effect.”

The '939 application is related to the cooling of an outer rotor type permanent magnet water pump, where the arrangement of the impeller, motor, and pressure sensor offers an improved thermal dissipation. The '939 application solely focuses on the heat dissipation of the stator, where the working medium water is used to directly cool the front-end cover connected with the stator core. In addition, a heat conducting glue is arranged between the stator core and the front-end cover to improve the cooling.

The '939 application does not disclose or teach that the heat-producing power electronics receive active cooling. Active cooling of the power electronics (variable speed drive electronics) allows the power electronics to function in an enclosed space without which the variable speed electronics are prone to failure due to excessive heat build-up inside the enclosure.

Disclosed herein are embodiments including a variable speed pump improves the heat dissipation of the variable speed power electronics and the outer rotor electric machine for applications such as pumping, heating, ventilation, air conditioning (PHVAC) and industrial applications.

### SUMMARY

In order to achieve the aforementioned objectives, embodiments consistent with the present invention include a variable speed pump for applications such as PHVAC and industrial applications.

According to embodiments consistent with the present invention, the variable speed pump may comprise a wetend/fluid compartment, a variable speed drive comprising power electronics and cover, a liquid cooling plate and an outer rotor permanent magnet motor, all enclosed by the housing and wetend/fluid compartment.

In accordance with embodiments consistent with the present invention, the wetend/fluid compartment may comprise a fluid inlet, an outlet and a spinning impeller that is rotatably mounted. The spinning impeller sucks the fluid in from the fluid inlet and ejects it out through the outlet of the wetend/fluid compartment. The impeller is connected via a shaft to the outer rotor motor that spins the impeller.

Furthermore, the variable speed drive may comprise power electronics and a cover. The power electronics are screwed and moulded into the rear section of the wetend/fluid compartment which is thermally conductive (between 10 to 30 W/mK). In some embodiments, thermal paste or pads may not be required as an interface between the power electronics and the rear section (b) as the two parts are in contact with each other. One of the methods of forming this contact is to directly mould the rear section (b) onto the power electronics thereby creating a fused contact. By fused contact, the parts can be touching.

Since the printed circuit board (PCB made from either a high-temperature FR4 material or a substrate material with thermal conductivity such as 200-400 W/mK) of the power electronics is fused contact with section (b) which is also an insulative material (greater than 2500 V/mm dielectric strength). The high thermal conductivity extracts heat out from the power electronics and transfers this heat to the flowing liquid inside the wetend/fluid compartment. No thermal paste or heat conducting glue or thermal pads are necessary with this direct cooling method.

In embodiments consistent with the present invention, the liquid cooling plate may be screwed to the cover of the variable speed drive. Screws are used to fix the cover and the liquid cooling plate in position with the wetend/fluid compartment. The screws pass through the openings in the variable speed drive electronics. On the opposite side of the liquid cooling plate, the outer rotor motor stator hub is mounted. The liquid cooling plate further comprises cooling pipes to carry, circulate and discharge the fluid for liquid cooling.

According to embodiments consistent with the present invention, the electric motor of the variable speed pump may be an outer rotor permanent magnet motor, comprising a stator with concentrated windings and a rotor disposed on the outside of the stationary stator on a shaft. The rotor further comprises permanent magnets embedded in the inner diameter of the rotor, that rotates with the rotor. The front face of the rotor body has vanes attached, to circulate air inside the pump.

The liquid cooling plate is positioned in a manner to provide a dual cooling function from both sides. On one side, the power electronics cover is directly connected to the liquid cooling plate and on the opposite side, the stator hub is also connected to the liquid cooling plate. For example, the power electronics cover may include a plate that is positioned against or adjoining a surface of the liquid cooling plate. The heat from the two sides is extracted by the flowing liquid inside the cooling plate. This technique greatly reduces the overall size of the variable speed pump.

It should be understood by a person skilled in the art that the power electronics that is positioned and facing the cover can also be in contact with the cover via thermal pads of different thicknesses. This allows the power electronic components on the opposite side of the PCB to be cooled by the liquid cooling plate via the cover. This contraption allows dual cooling of the power electronics i.e., direct cooling of power electronic components on both sides of the PCB through liquid cooling.

According to some embodiments, a variable speed pump may comprise, a fluid inlet configured to receive fluid, a fluid outlet configured to expel fluid, an impeller in a fluid compartment between the inlet and the outlet, wherein the impeller is mounted on a shaft connected to an electric motor, a variable speed drive positioned adjoining the fluid compartment, wherein the variable speed drive includes power electronics, and a liquid cooling plate comprising cooling pipes, wherein the liquid cooling plate is interposed between the power electronics and the electric motor, wherein the cooling pipes are configured to receive liquid through an inlet pipe and discharge the liquid through an outlet pipe.

In some embodiments, electric motor comprises a rotor arranged on the outside of a stator, wherein the stator comprises concentrated windings. In some embodiments, the liquid cooling plate provides cooling to the concentrated windings. In some embodiments, the power electronics comprises a thermally conductive printed circuit board. In some embodiments, the thermally conductive printed circuit board is screwed and molded to the liquid cooling plate. In some embodiments, the thermally conductive printed circuit board is configured to transfer heat from the power electronics to the fluid within the wetend/fluid compartment and the liquid cooling plate.

In some embodiments, the rotor comprises one or more permanent magnets and a rotor hub, wherein the one or more permanent magnets are mounted on an inner diameter of the rotor hub to restrict the displacement of magnets during rotation. In some embodiments, a cover encapsulates the power electronics and transfers heat from the power electronics to the liquid cooling plate. In some embodiments, a housing encapsulates one or more of the variable speed drive, electric motor, and the liquid cooling plate, wherein the housing comprises an air intake port configured to allow passage of air to cool drive or electric motor. In some embodiments, the electric motor comprises a rotor and the rotor comprises one or more vanes to circulate air as the rotor rotates.

In some embodiments, the housing may comprise an outlet for air from the air intake port. In some embodiments, the power electronics are mounted on a surface and the surface is positioned adjacent to or adjoining the wetend/fluid compartment. In some embodiments, the power electronics comprise one or more heat sink fins positioned proximate to the wetend/fluid compartment or the liquid cooling plate. In some embodiments, an input comprises an electronic communication with the variable speed drive to change a speed of electric motor.

An objective of the present invention is to provide a compact variable speed pump comprising a liquid-cooled variable speed power electronics which is small and power dense, an outer rotor permanent magnet electric machine with concentrated windings, that offers efficient thermal dissipation, energy efficiency and lower manufacturing cost.

Another objective of the present invention is to reduce the amount of active materials used in the motor which reduces the cost of the variable speed pump.

Thus, embodiments consistent with the present invention provides a compact, cost-effective variable speed pump which provides efficient cooling to the power electronics and the outer rotor permanent magnet electric machine.

### BRIEF DESCRIPTION OF THE DRAWINGS

The present invention will be better understood fully from the detailed description that is given herein below with reference to the accompanying drawings of embodiments of the present invention, which, however, should not be deemed to be a limitation to the invention to the specific embodiments, but are for the purpose of explanation and understanding only.

FIG. 1 is the exploded view of the variable speed pump, according to the present invention; and

FIG. 2 is the cut section of the variable speed pump.

FIG. 3 is the sectional view of the variable speed pump.

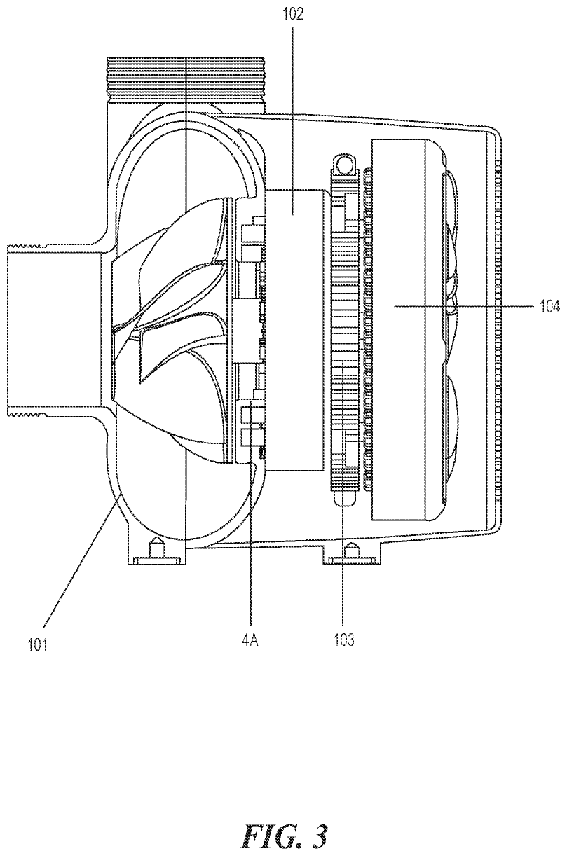

### DETAILED DESCRIPTION

Embodiments consistent with the present invention include improved cooling of the electronics and the outer rotor motor of a variable speed pump with simpler and lighter construction for applications such as PHVAC and industrial applications.

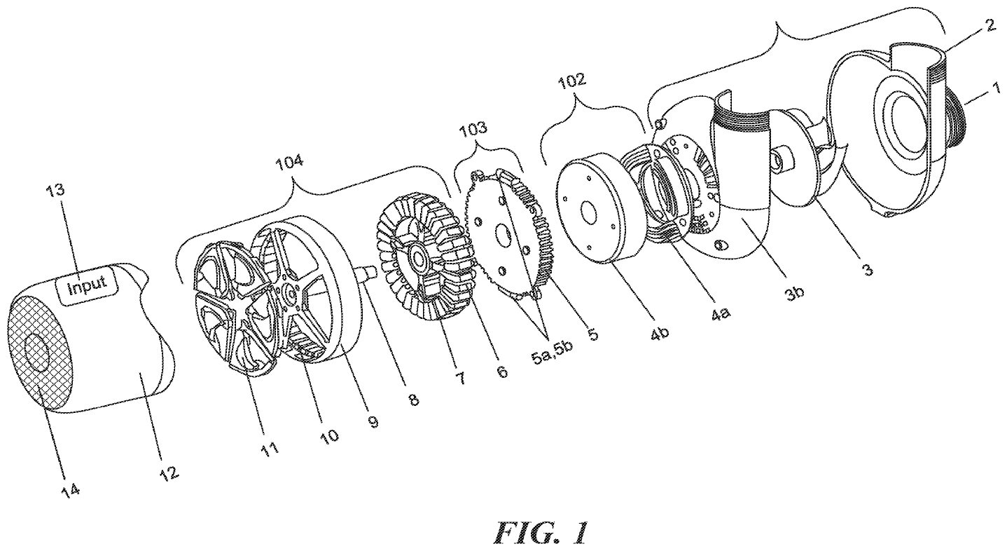

The variable speed pump primarily comprises a wetend/fluid compartment (101), a variable speed drive (102), a liquid cooling plate (103) and an outer rotor permanent magnet (104) arranged in a manner as depicted in FIG. 1.

The wetend/fluid compartment (101) has a fluid inlet (1) and an outlet (2), wherein the fluid is sucked through the inlet (1) into the middle of the spinning impeller (3). The liquid is forced out radially and passes through the outlet (2). The impeller (3) is directly mounted on an elongated shaft (8) that is connected to the outer rotor electric motor (104) and passes through the middle of the variable speed drive (102) and the liquid cooling plate (103).

The variable speed drive (102) has power electronics (not shown), PCB (4a) and is enclosed in a cover (4b) and it is strategically positioned adjoining the wetend/fluid compartment (101) as the heat generated by the electronics (not shown) is transmitted to the flowing liquid.

The printed circuit board (PCB) (4a) of the power electronics is screwed and moulded to the rear section (3b) of the wetend/fluid compartment (101) which can be thermally conductive (between 10 to 30 W/mK). Although embodiments could include thermal paste, heat-conducting glue, or thermal pads, no thermal paste or heat conducting glue or thermal pads are necessary with this direct cooling method.

Since the printed circuit board (4a) of the power electronics is in contact with section (3b) which is also an insulative material (e.g., greater than 2500 V/mm dielectric strength), the high thermal conductivity of the PCB (4a) allows heat to be extracted from the power electronics and transfer to the flowing liquid inside the wetend/fluid compartment (101). The PCB may comprise or be produced from a high-temperature FR4 material or a substrate material (e.g., with a thermal conductivity such as 200-400 W/mK or with a thermal conductivity sufficient to transfer heat of power electronics).

The liquid cooling plate (103) having cooling pipes (5a, 5b) interposed between the cover (4b) comprising power electronics (not shown) and the outer rotor motor (104) as shown in FIG. 1. The cooling pipes (5a, 5b) carry liquid through the inlet pipe (5a) and discharge through the outlet pipe (5b). This effectively cools both the power electronics on one side and the motor windings (7) on the other side.

Still referring to FIG. 1, the outer rotor motor (104) comprises a rotor (9) arranged on the outside of the stator (6), where the stator (6) comprising concentrated windings (7). A plurality of permanent magnets (10) is mounted on the inner diameter of the rotor hub to restrict the displacement of magnets during high-speed rotation due to centripetal forces. Furthermore, the eddy current losses may be reduced by laminating the magnets. The outer rotor (9) is driven in a variable speed mode by the variable speed drive (102).

During operation, the motor (104) and the variable speed drive (102) combined, generate between 5% to 20% of the power as heat and it is important to dissipate this heat for the proper and effective functioning of the pump without component failures.

The heat generated by the power electronics (not shown) of the variable speed drive (102) is dissipated into the flowing liquid as it is in “fused contact” with the rear end section (3b) of the wetend/fluid compartment (101) from one side and the liquid cooling plate (103) through the cover (4b) and the thermal pad on the other side.

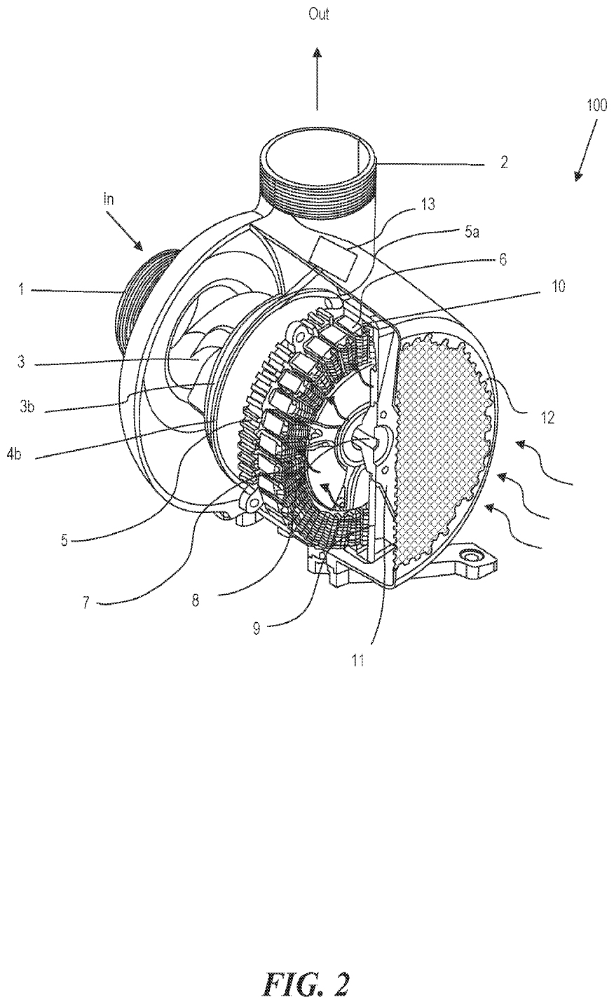

On the other hand, the heat from the stator (6) and windings (7) is primarily dissipated via the liquid cooling plate (103) which is in direct contact with the stator (6) as shown in FIG. 2.

In addition to liquid cooling, the electric motor (104) may also be air cooled, where the air is circulated through an air intake port (14) of the housing (12).

In one embodiment, the port (14) circulates the air through the outer rotor motor (104), which channels the air towards the windings (7) and blows it out through the housing (12).

In another embodiment, the air circulates only internally when the housing (12) is closed without any ventilation holes. The housing thus restricts any foreign matters to enter the pump.

Advantageously, the stator (6) is wound with concentrated windings (7), which reduces the usage of copper materials by more than 40% compared to distributed wound stators.

The pump (100) is powered using a mains cable or a DC power supply. The voltage can vary anywhere ranging from 12V to 1000V AC/DC. On powering up the variable speed drive (102), the user can input (13) pump speed requirements in order to operate the pump (100). They may also input a certain percentage of maximum power to control the pump (100). The input (13) drives the pump (100) to a desired speed of power level and circulates the liquid in the system. Varying the speed in such a way satisfies the cube law and saves energy consumption accordingly. For example, reducing the speed by 20% reduces the energy consumption by approximately 50%. Reducing the speed by 50% reduces the energy consumption by at least 88% of what it will be at full power (e.g., 100%).

In one embodiment the input (13) can be a keypad that is positioned on the housing (12) of the pump to input requirements such as speed, diagnostics, or selection of different modes of operations.

In another embodiment, the input (13) can be a wireless receiver and/or transmitter in communication with a console, a smartphone, or a server or device associated with an application. The wireless receiver and/or transmitter may communicate via Bluetooth or Wi-Fi or any other near-field communication method or by SMS message, radio, or any other long-range communication method.

The power electronics comprise power factor correction circuitry that improves the efficiency of the variable speed drive (102). The efficiency of the drive (102) remains high between 97% to 99% for speeds above 50%. The efficiency of the motor (104) in that speed range remains between 85% and 98%.

In order to reduce the production cost and time involved, the electric motor (104) may be manufactured using a slinky process, which reduces material wastage compared to conventional methods. The slinky process comprises forming a spiral winding to form the stator winding through one or more of compacting, straightening, punching, and rolling and to avoid or eliminate the cutting of a winding during formation.

Thus, the present invention provides embodiments including a simple, compact, cost-effective variable speed pump which provides efficient cooling for the power electronics and the outer rotor permanent magnet electric machine.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention as claimed.

1. A variable speed pump, comprising:
a. a fluid inlet (1) configured to receive fluid,
b. a fluid outlet (2) configured to expel fluid,
c. an impeller (3) in a fluid compartment between the inlet (1) and the outlet (2), wherein the impeller (3) is mounted on a shaft (8) connected to an electric motor (104);
d. a variable speed drive (102) positioned adjoining the fluid compartment, wherein the variable speed drive (102) includes power electronics; and
e. a liquid cooling plate (103) comprising cooling pipes (5a, 5b), wherein the liquid cooling plate is interposed between the power electronics and the electric motor (104), wherein the cooling pipes (5a, 5b) are configured to receive liquid through an inlet pipe and discharge the liquid through an outlet pipe,
wherein the electric motor (104) comprises a rotor (9) arranged on the outside of a stator (6), the liquid cooling plate (103) providing cooling to concentrated windings (7) of the stator (6).

2.-3. (canceled)

4. The variable speed pump of claim 1, wherein the power electronics comprises a thermally conductive printed circuit board (4a).

5. The variable speed pump of claim 4, wherein the thermally conductive printed circuit board (4a) is screwed and molded to the liquid cooling plate (103).

6. The variable speed pump of claim 4, wherein the thermally conductive printed circuit board (4a) is configured to transfer heat from the power electronics to the fluid within the wetend/fluid compartment (101) and the liquid cooling plate (102).

7. The variable speed pump of claim 1, wherein the rotor comprises one or more permanent magnets (10) and a rotor hub, wherein the one or more permanent magnets (10) are mounted on an inner diameter of the rotor hub to restrict the displacement of magnets during rotation.

8. The variable speed pump of claim 1, wherein a cover (4b) encapsulates the power electronics and transfers heat from the power electronics to the liquid cooling plate (103).

9. The variable speed pump of claim 1, wherein a housing (12) encapsulates one or more of the variable speed drive (102), electric motor (104), and the liquid cooling plate (103), wherein the housing (12) comprises an air intake port (14) configured to allow passage of air to cool drive (102) or electric motor (104).

10. The variable speed pump of claim 9, wherein the electric motor (104) comprises a rotor (9) and the rotor (9) comprises one or more vanes (11) to circulate air as the rotor rotates.

11. The variable speed pump of claim 9, wherein the housing (12) comprises an outlet for air from the air intake port (14).

12. The variable speed pump of claim 1, wherein the power electronics are mounted on a surface and the surface is positioned adjacent to or adjoining the wetend/fluid compartment (101).

13. The variable speed pump of claim 1, wherein the power electronics comprise one or more heat sink fins positioned proximate to the wetend/fluid compartment (101) or the liquid cooling plate (103).

14. The variable speed pump of claim 1, wherein an input (13) is in electronic communication with the variable speed drive (102) to change a speed of the electric motor (104).
